(19) United States
(12) Patent Application Publication
(10) Pub. No.: US 2024/0217501 A1
(43) Pub. Date: Jul. 4, 2024

(54) BRAKE CONTROL DEVICE FOR A VEHICLE AND METHOD FOR OPERATING A BRAKE CONTROL DEVICE

(71) Applicant: Robert Bosch GmbH, Stuttgart (DE)

(72) Inventors: Martin Marquart, Reichenbach (DE); Florian Haag, Ellhofen (DE); Nikolas Loeffelmann, Dielheim (DE)

(21) Appl. No.: 18/563,055

(22) PCT Filed: May 25, 2022
(86) PCT No.: PCT/EP2022/064219

§ 371 Date: Nov. 21, 2023

(30) Foreign Application Priority Data
Jun. 1, 2021 (DE) 10 2021 205 579.6

(51) Int. Cl. B60T 17/22; B60T 8/88

(52) U.S. Cl. CPC B60T 17/221; B60T 8/88; B60T 2220/04; B60T 2270/402; B60T 2270/613

(57) ABSTRACT

A brake control device for a vehicle. The brake control device includes a control device, which can be connected to a brake booster device, to an electric machine of the vehicle, and to a driving stability system; a pedal sensor device, which is connected to the control device, wherein the control device is configured to infer, from the pressing of the brake pedal and/or the gas pedal, a braking request from a driver, to identify an operational failure or an operational fault of the brake booster device, and, if an operational failure or an operational fault of the brake booster device is identified after and/or upon a braking request, to control a braking action by means of the driving stability system.

### FIELD

The present invention relates to a brake control device for a vehicle and a method for operating a brake control device.

### BACKGROUND INFORMATION

Conventional drive concepts for electrically powered vehicles can rely on the braking effect of the electric machine. Brake force generators or boosters, which can be controlled electronically when braking operation is required, are used for this purpose. It is possible that a brake booster may fail or its operation can be restricted.

Electromechanical brake boosters and ESP systems can form a brake system together. A regenerative brake and/or a hydraulic brake can be activated by pressing the brake pedal, which is measured by the electronic brake booster.

If the electronic brake booster fails, the brake pressure boost can be built up by the ESP by means of a control function HBC as so-called hydraulic boost failure compensation, wherein it can occur that the generator remains deactivated due to a lack of actuation command from the brake pedal for deceleration of the vehicle.

German Patent Application No. DE 10 2012 216 590 A1 describes a method for operating a combined braking system for motor vehicles.

### SUMMARY

The present invention provides a brake control device for a vehicle and a method for operating a brake control device.

Preferred developments of the present invention are disclosed herein.

The present invention provides a brake control device for a vehicle and a method for operating a brake control device, wherein a braking action on a vehicle can be improved during an operational fault or operational failure of a brake booster device.

It is advantageously possible to take into account the current capability of an electric machine as a generator for its operational capability. This can be used to generate a total braking torque by the electric machine and by a hydraulic brake system.

The aforementioned brake control device and method can improve robustness against a double fault, such as an operational fault in the brake booster device and in a driving stability system. In the event of a fault, on-board power supply support can be provided.

Robustness against double faults in the brake booster and ESP can also be achieved by consistently using the generator as a fallback.

By improving the distribution of the braking torque components, an improvement in the operation of the electric vehicle can be achieved in terms of NVH (noise, vibration, harshness). The improved NVH can result if the ESP pump can be used less due to a lower power requirement. The load on the ESP can be reduced by increasing the use of the generator.

Furthermore, the generation of braking force and the electric drive can be made more efficient. This can result in greater efficiency in energy recovery, since recuperation can continue to be used even after a brake booster failure. By generating the braking torque proportionally, the generation of brake dust, for example on a friction brake, can be advantageously reduced.

According to an example embodiment of the present invention, the brake control device for a vehicle, with which a braking action of the vehicle can be controlled, comprises a control device, which is connected or can be connected to a brake booster device and to an electric machine of the vehicle and to a driving stability system of the vehicle; a pedal sensor device, which is connected to the control device and which is designed to determine a pressing of a brake pedal and/or a gas pedal in the vehicle, wherein the control device is designed to infer, from the pressing of the brake pedal and/or gas pedal, a braking request from a driver; to identify an operational failure or an operational fault of the brake booster device; and, if an operational failure or an operational fault of the brake booster device is identified after and/or upon a braking request, to control a braking action by means of the driving stability system.

According to an example embodiment of the present invention, in the event of a failure or reduced performance of the electronic brake booster, it is advantageous to use an HBC actuation command from the ESP (driving stability system) and to control the electric machine as a generator in braking mode by means of a measured brake pressure from a pedal. For this purpose, an HBC signal can also be transmitted from the brake booster device itself to the electric machine and can trigger the generation of a regenerative braking torque, for example in combination with an HBC signal from the ESP or alternatively, wherein the brake booster device or a controller in it can then also emit its own HBC signal.

In general, according to an example embodiment of the present invention, a failure of the electric brake booster can be identified by the ESP and/or the control device and the driver braking request can be measured by means of the pressure sensor in the ESP. Furthermore, a driver braking request can be transmitted from the brake booster to the ESP by means of an HBC signal (hydraulic boost failure compensation). Depending on the pressure measured at the pedal, an actuation command for the generator can be transmitted by the ESP. The generator can decelerate the vehicle and thus supports the driver with its mechanical braking force.

If the generator deceleration is limited (for example, due to a dependency on the speed), an additional hydraulic brake pressure can be built up by the ESP pump.

The generator can be used directly on the basis of the HBC signal from the ESP or from the brake booster device. The brake booster can optionally (if still possible) also send its unavailability signal, for example to the ESP and/or to the electric machine. This can also be used directly by the generator to build up braking torque, provided that it coordinates with the ESP by means of an internal generator function about its contribution to the total braking torque.

According to a preferred embodiment of the brake control device of the present invention, the control device is designed to generate a regenerative braking torque on the electric machine if an operational failure or operational fault of the brake booster device is identified.

The regenerative braking torque can be generated from recuperation on the electric machine.

According to a preferred embodiment of the brake control device of the present invention, the control device is designed to forward a command for a braking action by the driving stability system to the electric machine, thereby prompting it to generate a regenerative braking torque.

The driving stability system can generate a signal for the electric machine to support conventional braking by means of a regenerative braking torque.

According to a preferred embodiment of the brake control device of the present invention, the control device is designed to forward a command for a braking action by the brake booster device to the electric machine, thereby prompting it to generate a regenerative braking torque.

According to a preferred embodiment of the brake control device of the present invention, it is connected to and/or comprises a control device for a hydraulic braking action, wherein a command for a braking action can be controlled by the driving stability system and/or by the brake booster device by means of the control device for a hydraulic braking action.

According to a preferred embodiment of the brake control device of the present invention, the pedal sensor device is connected to the driving stability system and/or to the brake booster device and the braking request of the driver can be identified by the control device by means of the pedal sensor device at the driving stability system and/or at the brake booster device and the generation of a regenerative braking torque can thereby be controlled.

The driver request can be controlled advantageously by the identified action on the gas and/or brake pedal.

According to a preferred embodiment of the brake control device of the present invention, the pedal sensor device is designed to identify a pressing and/or a position of the brake pedal and/or gas pedal and the control device is designed to infer, from the pressing and/or the position of the brake pedal and/or gas pedal, an extent of a braking request and to generate this at least partially on the electric machine.

Depending on the extent, a required or desired braking effect can be deduced and this can be taken into account to generate the regenerative and/or total braking torque.

According to an example embodiment of the present invention, with the method for operating a brake control device for a vehicle in order to control a braking action of the vehicle, an identification of a need to carry out a braking action with a brake control device according to the present invention is carried out, wherein a pressing of a brake pedal and/or a gas pedal in the vehicle is identified by a pedal sensor device and the presence of a braking request by a driver is deduced; an identification of an operational failure or an operational fault of the brake booster device; a generation of a braking torque and/or carrying out of a braking action on and/or by the driving stability system on the vehicle in the event of and/or after an operational failure or an operational fault of the brake booster device has been identified.

The braking action can be a braking action on the vehicle to slow down the rotation of wheels, for example with a friction braking torque and/or a regenerative braking torque and/or any other type of braking force on the vehicle.

A delay can be stopped according to a preset on the vehicle, wherein the preset can also be selected by the user as low or high (strong) as desired. A brake actuator device to be controlled can be a friction brake of any type, or any other type of conventional or other non-regenerative brake.

According to an example embodiment of the present invention, the operating state of the electric machine as a generator can be determined, which can correspond to a degree to which the electric machine can apply a regenerative braking torque at the moment or in general, for example for an intended speed range, at a certain mileage, at a certain temperature, at an estimable available battery charge/power and other operation-specific parameters for an electric vehicle. Depending on the knowledge of the capability of the electric machine as a generator and thus as a device generating regenerative braking torque, the regenerative (first) braking torque can then be increased and/or reduced, for example in a manner adaptively adjustable and dynamically over time, in order to meet a preset of a minimum braking torque, for example which can always be available to the vehicle, and which can be a sum of the first and a further, for example hydraulic (second) braking torque, or one of these individually.

By taking the generator component into account in this way, a requirement for the minimum operating mode of the brake actuator can be reduced. In doing so, it is necessary for the brake actuator to know the current capability of the generator.

The vehicle can be a passenger car with a drive system that can comprise an electric machine.

According to a preferred embodiment of the method of the present invention, a necessary value of a total braking torque is determined and such a regenerative braking torque is requested from an electric machine and generated, and a braking torque is requested from the driving stability system at a braking device and generated, so that a sufficient total braking torque that satisfies a preset value is generated.

According to a preferred embodiment of the method of the present invention, a command for a braking action is forwarded by the driving stability system to the electric machine, thereby prompting it to generate a regenerative braking torque.

According to a preferred embodiment of the method of the present invention, a command for a braking action is forwarded to the electric machine by the brake booster device, thereby prompting it to generate a regenerative braking torque.

According to a preferred embodiment of the method of the present invention, a pressing and/or a position of the brake pedal and/or gas pedal is identified by the pedal sensor device and an extent of a braking request is inferred from the pressing and/or the position of the brake pedal and/or gas pedal and a corresponding braking torque is generated at least partially by a generator on the electric machine.

According to a preferred embodiment of the method of the present invention, a regenerative braking torque that can currently be generated on the electric machine is determined, and this is compared with a braking request and a total braking torque is either applied only to the electric machine or is generated on the vehicle with the assistance of a braking device.

The braking device can be a hydraulic braking device or any other type of braking device for a vehicle.

According to a preferred embodiment of the method of the present invention, the operating state of the electric machine and the resulting regenerative braking torque on the electric machine are determined continuously or at predetermined time intervals.

The brake control device of the present invention can also be characterized by the features and advantages mentioned in connection with the method of the present invention and vice versa.

Further features and advantages of embodiments of the present invention will become apparent from the following description with reference to the figures.

### BRIEF DESCRIPTION OF THE DRAWINGS

The present invention is explained in more detail below based upon the exemplary embodiments indicated in the schematic figures.

FIG. 1 shows a schematic representation of a brake control device according to an exemplary embodiment of the present invention.

FIG. 2 shows a schematic representation of a control curve of the braking request at the brake control device according to an exemplary embodiment of the present invention.

FIG. 3 shows a block diagram of method steps of the method for operating a brake control device according to an exemplary embodiment of the present invention.

### DETAILED DESCRIPTION OF EXAMPLE EMBODIMENTS

In the figures, identical reference signs denote identical or functionally identical elements.

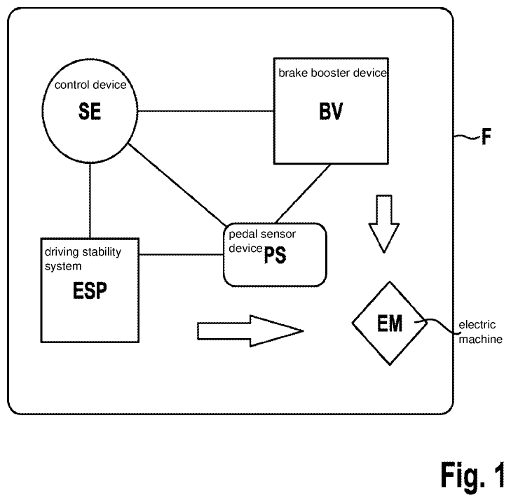

FIG. 1 shows a schematic representation of a brake control device according to an exemplary embodiment of the present invention.

The brake control device 10 for a vehicle F, with which a braking action of the vehicle can be controlled, comprises a control device SE, which is connected or can be connected to a brake booster device BV and to an electric machine EM of the vehicle and to a driving stability system ESP of the vehicle; a pedal sensor device PS, which is connected to the control device SE and which is designed to determine a pressing of a brake pedal and/or a gas pedal in the vehicle, wherein the control device SE is designed to infer, from the pressing of the brake pedal and/or gas pedal, a braking request by a driver; to identify an operational failure or an operational fault of the brake booster device; and, if an operational failure or operational fault of the brake booster device BV is identified after and/or upon a braking request, to control a braking action by means of the driving stability system ESP.

The control device SE can be designed to forward a command for a braking action by the driving stability system ESP to the electric machine EM, thereby prompting it to generate a regenerative braking torque, and/or to forward a command for a braking action by the brake booster device BV to the electric machine EM, thereby prompting it to generate a regenerative braking torque.

The pedal sensor device PS can be connected to the driving stability system and/or to the brake booster device BV and the braking request of the driver can be identified by the control device SE by means of the pedal sensor device PS at the driving stability system and/or at the brake booster device BV and the generation of a regenerative braking torque can thus be controlled.

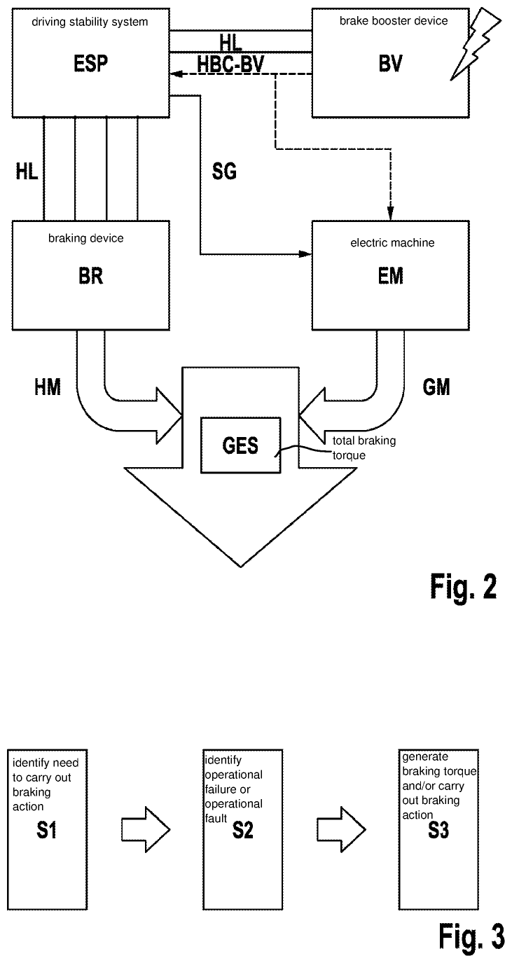

FIG. 2 shows a schematic representation of a control curve of the braking request at the brake control device according to an exemplary embodiment of the present invention.

The representation in FIG. 2 is similar to that in FIG. 1, wherein the control actions are from FIG. 1 and additional control actions are shown schematically.

The brake booster BV can be connected to the driving stability system ESP by means of hydraulic lines HL. The driving stability system ESP can be connected to a braking device BR by means of hydraulic lines HL. In order to transmit a signal about a braking request and/or about an operational failure or operational fault, for example of the brake booster device BV, the brake booster device BV can be connected by means of a signal line to the driving stability system ESP and/or to the electric machine EM and transmit a direct request (HBC-BV) for the regenerative braking torque to the electric machine EM, if the brake booster device BV is still functioning to this extent, wherein information about the presence of the operational fault can also be transmitted to the electric machine and a correspondingly higher regenerative braking torque or any regenerative braking torque GM at all can be generated. Additionally or alternatively, such signal HBC-BV can be transmitted by the brake booster device BV to the driving stability system ESP by means of the operational fault and/or operational failure, if still possible, in order to inform the driving stability system ESP of the fault. The driving stability system ESP can then use its own signal SG to request the electric machine to generate a regenerative braking torque GM. In addition, the driving stability system ESP can control the BR braking device and request a conventional braking torque (for example, by friction or hydraulic braking torque HM) from it. A total braking torque GES can then be generated from both braking torques GM and HM. In this way, the control of the electric machine can be used for a mechanical fallback level if there is an operational fault or operational failure at the brake booster device BV. The driving stability system ESP can be used to calculate a maximum regenerative braking torque that can be generated and taken into account when the total braking torque is to be generated, for example at the extent of the conventional braking torque HM.

The braking device BR can comprise brake calipers, for example.

FIG. 3 shows a block diagram of method steps of the method for operating a brake control device according to an exemplary embodiment of the present invention.

With the method for operating a brake control device for a vehicle to control a braking action of the vehicle, an identification S1 of a need to carry out a braking action with a brake control device according to the present invention is carried out, wherein a pressing of a brake pedal and/or a gas pedal in the vehicle is identified by a pedal sensor device and the presence of a braking request by a driver is deduced; an identification S2 of an operational failure or an operational fault of the brake booster device; a generation S3 of a braking torque and/or carrying out of a braking action on and/or by the driving stability system on the vehicle in the event of and/or after an operational failure or an operational fault of the brake booster device has been identified.

Although the present invention has been completely described above with reference to preferred exemplary embodiment, it is not limited thereto, but rather can be modified in many ways.

1-13. (canceled)

14. A brake control device for a vehicle, using which a braking action of the vehicle can be controlled, the brake control device comprising:
a control device, which is connected or can be connected to a brake booster device, to an electric machine of the vehicle, and to a driving stability system of the vehicle; and
a pedal sensor device, which is connected to the control device and which is configured to determine a pressing of a brake pedal and/or a gas pedal in the vehicle;
wherein the control device is configured to:
infer, from the pressing of the brake pedal and/or gas pedal, a braking request by a driver,
identify an operational failure or an operational error of the brake booster device; and
control, based on identifying an operational failure or an operational fault of the brake booster device after and/or upon a braking request, a braking action using the driving stability system.

15. The brake control device according to claim 14, wherein the control device is configured to generate a regenerative braking torque on the electric machine when an operational failure or operational fault of the brake booster device is identified.

16. The brake control device according to claim 15, wherein the control device is configured to forward a command for a braking action by the driving stability system to the electric machine, thereby prompting the electric machine to generate a regenerative braking torque.

17. The brake control device according to claim 15, wherein the control device is configured to forward a command for a braking action by the brake booster device to the electric machine, thereby prompting the electric machine to generate a regenerative braking torque.

18. The brake control device according to claim 14, wherein the brake control device is connected to and/or includes a control device for a hydraulic braking action, wherein a command for a braking action can be controlled by the driving stability system and/or by the brake booster device using the control device for a hydraulic braking action.

19. The brake control device according to claim 14, wherein the pedal sensor device is connected to the driving stability system and/or to the brake booster device, and wherein the braking request of the driver can be identified by the control device using the pedal sensor device at the driving stability system and/or at the brake booster device and the generation of a regenerative braking torque can thereby be controlled.

20. The brake control device according to claim 14, wherein the pedal sensor device is configured to identify the pressing and/or a position of the brake pedal and/or gas pedal, and the control device is configured to infer, from the pressing and/or the position of the brake pedal and/or gas pedal, an extent of a braking request and to generate the braking at least partially on the electric machine.

21. A method for operating a brake control device for a vehicle to control a braking action of the vehicle, comprising the following steps:
identifying a need to carry out a braking action with a brake control device, wherein a pressing of a brake pedal and/or a gas pedal in the vehicle is identified by a pedal sensor device and a presence of a braking request by a driver is deduced;
identifying an operational failure or an operational fault of the brake booster device; and
generating a braking torque and/or carrying out a braking action on and/or by a driving stability system on the vehicle in the event of and/or after an identified operational failure or an operational error of the brake booster device.

22. The method according to claim 21, wherein a necessary value of a total braking torque is determined and a regenerative braking torque is requested from an electric machine and generated, and a braking torque is requested from the driving stability system at a braking device and generated, so that a sufficient total braking torque that satisfies a preset value is generated.

23. The method according to claim 21, wherein a command for a braking action is forwarded by the driving stability system to the electric machine, thereby prompting the electric machine to generate a regenerative braking torque.

24. The brake control device according to claim 21, wherein a command for a braking action is forwarded by the brake booster device to the electric machine, thereby prompting the electric machine to generate a regenerative braking torque.

25. The method according to claim 21, wherein the pressing and/or a position of the brake pedal and/or gas pedal is identified by the pedal sensor device and an extent of a braking request is inferred from the pressing and/or the position of the brake pedal and/or gas pedal, and a corresponding braking torque is generated at least partially by a generator on the electric machine.

26. The method according to claim 22, wherein a regenerative braking torque that can currently be generated is determined on the electric machine, and the determined regenerative braking torque is compared with the braking request, and the total braking torque is either applied only to the electric machine or is generated on the vehicle with assistance of a hydraulic braking device.
